(19) United States
(12) Patent Application Publication
(10) Pub. No.: US 2016/0049010 A1
(43) Pub. Date: Feb. 18, 2016

(54) DOCUMENT INFORMATION RETRIEVAL FOR AUGMENTED REALITY DISPLAY

(71) Applicant: TOP IMAGE SYSTEMS LTD., Ramat-Gan (IL)

(72) Inventor: Yuval HINSKI, Ramat-Gan (IL)

(21) Appl. No.: 14/778,635

(22) PCT Filed: Jun. 2, 2014
(86) PCT No.: PCT/IL2014/050498

§ 371 Date: Sep. 21, 2015

Related U.S. Application Data
(60) Provisional application No. 61/831,199, filed on Jun. 5, 2013.

(51) Int. Cl. G06T 19/00; G06K 9/00; H04N 5/232

(52) U.S. Cl. CPC G06T 19/006; H04N 5/23229; G06K 9/00442

(57) ABSTRACT

According to some embodiments of the present invention there is provided a computerized method to generate an augmented document display. The method may comprise receiving a document image from an augmented reality device, wherein the document image images a document currently viewed by a user. The method may comprise processing the document image to identify an image content data of the document. The method may comprise selecting one of two or more document records based on the image content data. The method may comprise identifying a current workflow step of the document from two or more document workflow steps, using the selected document record. The method may comprise determining one or more document support data based on the current workflow step. The method may comprise instructing the augmented reality device to display the one or more document support data when the document is viewed by the user.

### BACKGROUND

The present invention, in some embodiments thereof, relates to enterprise document information retrieval and, more specifically, but not exclusively, to document information retrieval for augmented reality displays.

In business environments, digital information systems store data extracted from paper documents and are used for issuing documents based on digital records. Electronic document are more convenient to distribute, store, access, and archive, but many document activities require additional printed documents. While these printed documents may be scanned and stored electronically, the printed versions must also be managed according to a separate specific workflow for the printed document type and/or specific document. For example, documents associated with a certain event, such as obtaining a mortgage for a real estate property, are filed both electronically and in printed document files and are processed through the organization based on a mortgage approval workflow. Many legal, financial and audited actions require that the printed documents be filed as evidence in addition to electronic documents. While the electronic documents may be cross-referenced and associated with electronic workflows and electronic document verification systems, the printed documents are at most associated with checklists and visual confirmations by a user handling the document. For example, electronic mortgage documents may be linked electronically to a customer's electronic financial records and stored credit rating.

Document management systems (DMS) are electronic, computerized systems which allow organizations, such as businesses, to store, process, and manage documents within the organization, and are typically part of large enterprise content management systems. The documents are mostly electronic documents, but many systems or subsystems may manage printed documents as well. For example, legal, regulatory, and or financial documents are stored both electronically as scanned documents and in printed documents files for auditing and legal purposes.

The DMS will use a database to manage the documents in the system, and the database contains a document record for each document. The database is a collection of data, typically organized to model in ways to support processes requiring this data. The document record contains fields comprising field names and values. Some of the fields are information appearing in the document and some of the fields are additional information associated with the document, such as information used in the processing of the document or recording the context of the document. As used herein the term meta-data means the additional information associated with the document for assistance. For example, meta-data includes the date and/or location a document is stored and the identity of the user who stored the document. The processing of a document in the DMS is associated with a specific workflow for that document that describes the steps and/or stages of the processing of that document through the organization. The step and/or stage that a particular document is currently located at within the workflow may be referred to herein as the step of the document within the workflow, or document workflow step while all the steps of the workflow for a particular document may be referred to as the workflow steps. Similar documents, such as document types, may share the same workflow steps, or optionally have customized modifications to the workflow steps for a particular instance of a document. A DMS may automatically extract meta-data from a document, prompt the user handling the document to add meta-data, use optical character recognition on scanned images, and the like. Other techniques, such as optical mark recognition (OMR), are sometimes used to extract values of check-boxes, bubbles, and other graphical information.

Many DMS establish workflow processes for documents, to handle the automation of document management across multiple steps that may be performed by multiple document handlers. Workflow steps for any specific document depend on the environment to which the electronic document management system (EDMS) is applied, the type of document, and any specific modifications to the workflow steps for a specific document. Manual workflow requires a user to view the document and decide whom to send it to.

Rules-based workflow allows an administrator to create a rule that dictates the flow of the document through an organization. For example, an invoice goes through an approval process and then is sent to the accounts-payable department for further processing. Dynamic rules allow a document workflow to have branches in a workflow process, depending on the document content. A simple example would be an invoice and if the amount is within a certain range of amounts, it follows different specific routes through the organization depending on the invoice value.

### SUMMARY

According to some embodiments of the present invention there is provided a computerized method to generate an augmented document display. The method may comprise receiving a document image from an augmented reality device, wherein the document image images a document currently viewed by a user. The method may comprise processing the document image to identify an image content data of the document. The method may comprise selecting one of two or more document records based on the image content data. The method may comprise identifying a current workflow step of the document from two or more document workflow steps, using the selected document record. The method may comprise determining one or more document support data based on the current workflow step. The method may comprise instructing the augmented reality device to display the one or more document support data when the document is viewed by the user.

Optionally, the current workflow step is identified using the image content data in addition to the selected document record.

Optionally, the one or more document support data is determining based on any from the two or more workflow steps, the selected document record, and the image content data in addition to the current workflow step.

Optionally, the image content data is any form a list of text data, numeric data, graphical data image data, and the like.

Optionally, each element of the image content data further comprises a location in the document image of each element of the image content data.

Optionally, the one or more document support data is any from a list of a document support action, a document support instruction, a document support suggestion, a value of the selected document record, one of the workflow steps, a value of one of the document records, and the like.

Optionally, the one or more document support data is one or more document modification data computed from a comparison of the selected document record and the image content data.

Optionally, the one or more document support data is determined from one or more field value of the selected document record.

Optionally, the one or more document support data comprises an instruction associated with the document image.

Optionally, the image content data comprises two or more values, a type of each value being any from a list of characters, numbers, pictures, images, logos, and the like.

Optionally, the image content data comprises two or more characters, and the characters are identified using optical character recognition.

Optionally, the one of two or more document records is selected by a best matching of the image content data to one or more value from the selected document record.

Optionally, the image content data matches two or more matching document records, and one of the matching document records is selected by receiving a user selection decision.

Optionally, the image content data matches two or more document records, and the selected document record is selected by comparing two or more previous user selection decisions associated with the document records.

Optionally, the document records are stored in any from a list of a table, a database, a server, a database server, and the like.

Optionally, the document records are two or more document clusters, the selected document record is a selected document cluster based on the image content data being related to the selected document cluster.

Optionally, the instructing of the augmented reality device to display the document support data comprises modifying a formatting of the document support data so that when viewed by the user the document support data appears as part of the document.

Optionally, the instructing of the augmented reality device to display the document support data further comprises instructing to display the document image in addition to the document support data.

Optionally, the selecting one of two or more document records is performed on secondary server device dedicated to storing of the document records.

Optionally, the determining document support data from the selected document record is performed on secondary server device dedicated to storing of the document records.

According to some embodiments of the present invention there is provided a computer readable medium comprising computer executable instructions adapted to perform the method of claim 1.

According to some embodiments of the present invention there is provided a computerized device for generating an augmented document display. The device may comprise one or more computerized processing unit for executing processor instructions. The device may comprise an identification module, which is configured to receive a document image from an augmented reality device, and identify an image content data of the document image. The device may comprise a selection module, which is configured to receive the image content data, select one of two or more document records, identify a document workflow step from two or more workflow steps using the selected document record, and determine one or more document support data based on the current workflow step. The device may comprise a display module, which receives the document support data, modifies a format of the document support data to correspond to the document image, and instructs the augmented reality device to display the document support data.

According to some embodiments of the present invention there is provided a computer program product for generating an augmented document display. The computer program product may comprise a computer readable storage medium. The computer readable storage medium may having stored thereon first program instructions executable by a computerized device to cause a device to capture a document image from an imaging sensor, wherein the document image images a document currently viewed by a user. The computer readable storage medium may having stored thereon second program instructions executable by the computerized device to cause the device to process the document image to identify an image content data of the document. The computer readable storage medium may having stored thereon third program instructions executable by the computerized device to cause the device to select one of two or more document records based on the image content data. The computer readable storage medium may having stored thereon fourth program instructions executable by the computerized device to cause the device to identify a current workflow step of the document from two or more workflow steps, using the selected document record. The computer readable storage medium may having stored thereon fifth program instructions executable by the computerized device to cause the device to determine one or more document support data based on the current workflow step. The computer readable storage medium may having stored thereon sixth program instructions executable by the computerized device to cause the device to instruct the augmented reality device to display the one or more document support data when the document is viewed by the user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention may involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an illustrative embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic illustration of a standalone augmented reality display device for presenting document support information in association with a document viewed using the augmented reality display device, according to some embodiments of the invention;

FIG. 1B is a schematic illustration of a system for providing document support information for presentation on an augmented reality display, according to some embodiments of the invention;

FIG. 1C is a schematic illustration of a system for providing document support data for presentation on an augmented reality display, comprising a standalone augmented reality display device, a client terminal, and a server, according to some embodiments of the invention;

FIG. 2 is a flowchart of a method for providing document support data for presentation on an augmented reality display, according to some embodiments of the invention;

FIG. 3 is an illustrative schematic drawing of a system and method for providing document support data for presentation on an augmented reality display, according to some embodiments of the invention; and

FIG. 4 is an illustrative schematic drawing of user view of a document and document support information for presentation on an augmented reality display, according to some embodiments of the invention.

### DETAILED DESCRIPTION

The present invention, in some embodiments thereof, relates to enterprise document information retrieval and, more specifically, but not exclusively, to document information retrieval for augmented reality (AR) displays.

Receiving a paper document and the associated documentation thereof in a digital document management system is usually performed in parallel processes, which involve manual operations performed when the paper document is received by a recipient, such as an organization. For example, when a legal document connected to a case is received at a legal firm, a paralegal personnel locates a digital record associated with that case from the database of records of the legal firm, marks the received document with the case file number, adds a document summary or a status to the digital record to indicate the reception thereof, locates a paper folder in the archives based on information from the database record in the paper document system, adds the paper document to the paper folder, transfers the paper folder to the handling attorney, and indicates that the paper document is processed by the attorney on the digital document system. In another example, when a letter is received in a mailroom, an entry is added to a mail tracking database by a mail handling personal after the addressee is identified. The addressee's physical mailbox is located in the mailroom and the letter is placed in the located mailbox. The mail tracking database record is updated that the mail item is in the mailbox. These manual interactions between the paper and digital document systems are time consuming, prone to user error, and are difficult to quantify for quality system evaluations.

Wearable computers, optical head-mounted displays, for example, Smart glasses such as Google™ Glass, are becoming more and more popular and allow users to interact with computerized devices based on position, image and voice commands. Augmented reality displays may be based on wearable devices, such as the Oculus Rift, or fixed position computerized devices, such as a computer peripheral camera and projector connected to a computer, and the like. As used herein, the term augmented reality device mean any computerized device that comprises a display viewable by the user, an imaging sensor(s)that captures images of the scene containing a printed document as viewed by the user, and one or more interfaces to connect with other computerized devices.

According to some embodiments of the invention, there are provided methods and AR display devices and/or systems for determining data associated with a document currently viewed by a user of the device, and presenting this document support data for aiding the wearer to make decisions regarding the document. The user may be any person viewing the document and needing to perform an action based on this document. The document identification and content is determined based on image analysis of a document image captured by an imaging sensor of the AR display device. The image analysis determines image content data which may include any feature of the document, such as text, numbers, graphics, images and the like that can assist in locating the document record in the database. Once the document and/or document type are located in the database, the step at which the document is within the workflow for this document is identified, such as the stage of preparation of the document. The document workflow and/or the image content data determine the document support data and/or instruction to display on the AR display device when the user is viewing the document. As used herein, the displayed data, referred to as herein document support data, may be any document enhancing information and/or document handling instructions, which aid the user handling the document in making decisions and/or actions regarding the currently imaged document.

The document image may be processed to identify content, classified, and/or analyzed to extract image content values, such as textual values, numerical values, graphical information, document-embedded images, and/or the like. The content values are compared to a list of the values of computerized document records, for example in a database, to find a matching document record. The workflow step for that specific document and/or document type is based on the matching document record. The workflow step allows choosing additional information from the matching database record, such as document support data, and send that document support data to the device to be displayed to the user handling the document, for example overlaid on the viewed document as seen by the user. The user viewing the document may then use the document support data together with the viewed document to make a decision about the next actions the user handling the document will take regarding the imaged document.

As used herein, the term user means the user viewing and/or handling the document, and is the same user that is using the AR display device and/or system. Optionally, the user viewing the document is one person performing a task. Optionally, the user may be two or more people collaboratively viewing, modifying, and/or handling a document.

Optionally, when a document record and/or document type is not found in the database, instructions are sent to the user viewing the document to collect additional information on the document. For example, the user viewing the document is instructed to turn the document over and document information is collected from the back side of the paper document. For example, the document is a multipage document and the user viewing the document is instructed to scan the other pages.

Optionally, decision history is analyzed for patterns and document workflow and/or document support data are computed by heuristic and/or machine learning methods. For example, a training period is recorded using the AR device and analyzed to determine the workflow process for legal documents at a lawyer's office.

Optionally, the document identification and/or document support data determination are performed on the AR device using an incorporated processor.

Optionally, the document identification and/or meta-data selection are performed on a client terminal, such as a smartphone, from a document image sent by the AR device to the client terminal. Optionally, the document identification and/or document support data determination are performed on one or more servers, such as a database server, form a document image sent by the AR device to the server.

Optionally, the AR device, client terminal, processing server, and/or database server are together a system for assisting the user viewing the document in a document-related decision.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

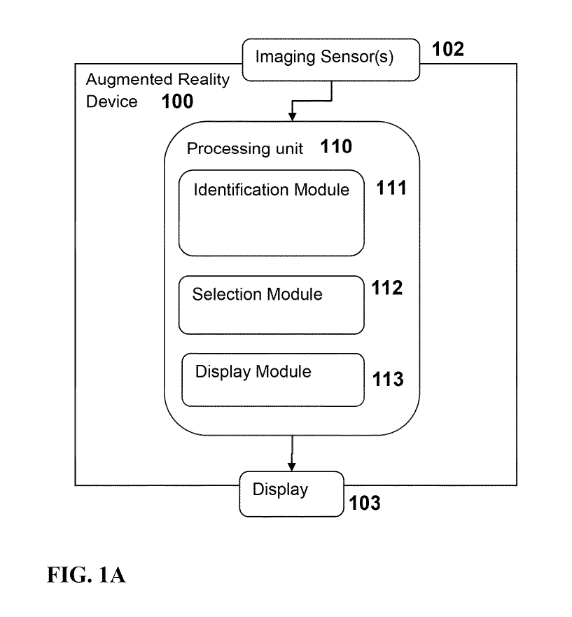

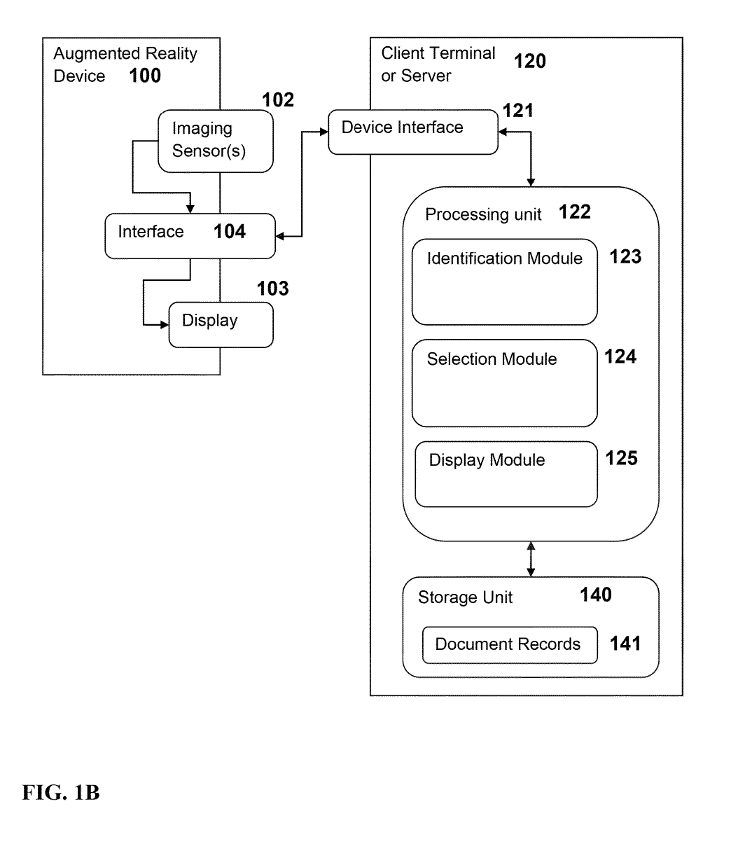

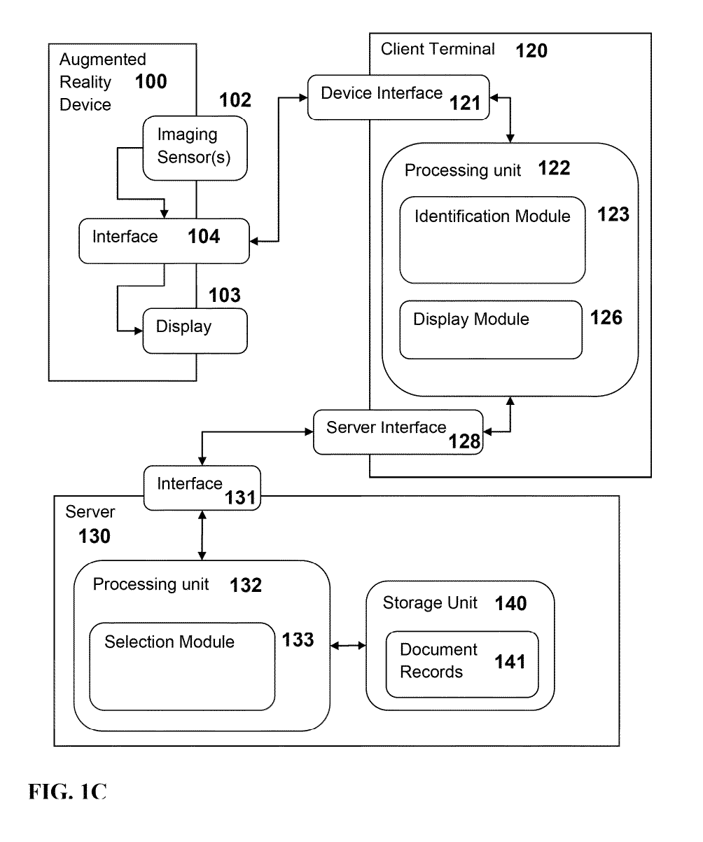

Reference is now made to FIG. 1A, which is a schematic illustration of a standalone augmented reality display device for presenting document support information in association with a document viewed using the augmented reality display device, according to some embodiments of the invention. The augmented reality devices comprises an imaging sensor(s)102 for capturing an image of a document in view of a user of the AR device, a processing unit 110 to execute processor instructions, and a display 103 to present document support data. The processing unit 110 may comprise an identification module 111, such as a collection of processor instructions, to automatically capture a document image and automatically identify the image content data. The image content data of a printed document is textual, numerical, graphical, and/or image data values that represent the information content printed on the document. For example, optical character recognition can convert the text viewed by the user in the document to character string values that are searchable by a computer processer in a database. The processing unit 110 may comprise a selection module 112 that automatically receives the image content data to automatically match the specific document being viewed by a user in a database of document records and/or document type records. The data base is a list of records of specific documents and/or document types in the electronic document management system, each record containing data values related to that document and/or document type. The selection module 112 may use the image content data to identify automatically the workflow step of the document, from the workflow steps assigned to the processing of that document and/or document type in the organization. The selection module 112 may determine the document support data that should be displayed to the user viewing the document, based on the workflow step, the document record, the document record type, and/or the image content data. The workflow step is one of a series of steps describing the workflow process for a specific document or a document type. The document support data is automatically sent to the display 103 to be viewed by the user along with the document using the display module 113. For example, the standalone AR device contains a document database within the internal memory of the processor unit, and the document support data is retrieved automatically from the internal database. The data base may contain a database of records of all specific documents and/or document type in the organization, such as an enterprise, and each record contains multiple fields with values relating to the specific document and/or document type. The image content data is searched for in the database to match a record of a specific document and/or a document type, the and these data are used to determine the workflow step in the processing of the document and the relevant data that needs to be displayed to the user viewing the document. Optionally, the database is located on a network attached server, and the AR device 100 further comprises a network interface. In this example, the selection module 112 accesses the database server to automatically locate the document record from which the document support data is determined automatically.

Reference is now made to FIG. 1B, which is a schematic illustration of a system for providing document support information for presentation on an augmented reality display, according to some embodiments of the invention. In this embodiment, the AR display device 100 is a peripheral component of a client terminal 120, such that the client terminal operates the imaging sensor(s) 102 and display 103 as remote input/output peripheral components of the client terminal 120. For example, the AR device 100 is a DigiLens® model DL40 connected by a Bluetooth interface to the client terminal 120. The client terminal 120 contains a device interface 121 to transfer data from and/or to the AR device 100, a processing unit 122, and a storage unit 140. The processing unit 122 may comprise an automatic identification module 123, which captures a document image from the imaging sensor(s) 102 of the AR device 100, and indentifies the image content data of that document image. The image content data may be transferred to an automatic selection module 124, which compares the image content data to document records 141 of a database stored on the storage device 140. The selection module 124 receives the document record from the storage device, indentifies the workflow step of the document and determines the document support data to display 125 to the user viewing the document on the AR device 100 display 103. The client terminal 120 device interface 121 is configured to communicate with the AR device 100 interface 104.

Reference is now made to FIG. 1C, which is a schematic illustration of a system for providing document support data for presentation on an augmented reality display, comprising a standalone augmented reality display device, a client terminal, and a server, according to some embodiments of the invention. The system comprises an AR display device 100, a client terminal 120 and a processing server 130. The AR display device 100 comprises an imaging sensor(s) 102, and interface 104 to the client terminal 120, and a display 103. The client terminal 120 comprises a device interface 121, a server interface 128, and a processing unit 122. The processing unit 122 comprises an identification module 123, which operates the AR device 100 to capture a document image from the imaging sensor(s) 102, and receives the document image through interfaces 104 and 121 to the processing unit 122. The identification module 123 of the processing unit 122 then identifies image content data of the document image and sends this data to the server 131 through the interfaces 128 and 131. The server comprises a network interface 131, a processing unit 123, and a storage unit for document records as in a database. The server processing unit 123 includes a selection module that receives the image content data, matches this image content data to one of the document records 141 in the storage unit 140, determines the document support data for that document, and sends the document support data to the client terminal 120. The client terminal in turn, uses the display module 126 to receive the document support data, format the document support data for display on the viewed document, and send the display instructions to the AR device display 103.

Optionally, other configurations of systems comprising AR devices, client terminals, servers and database servers are capable of implementing the methods described herein.

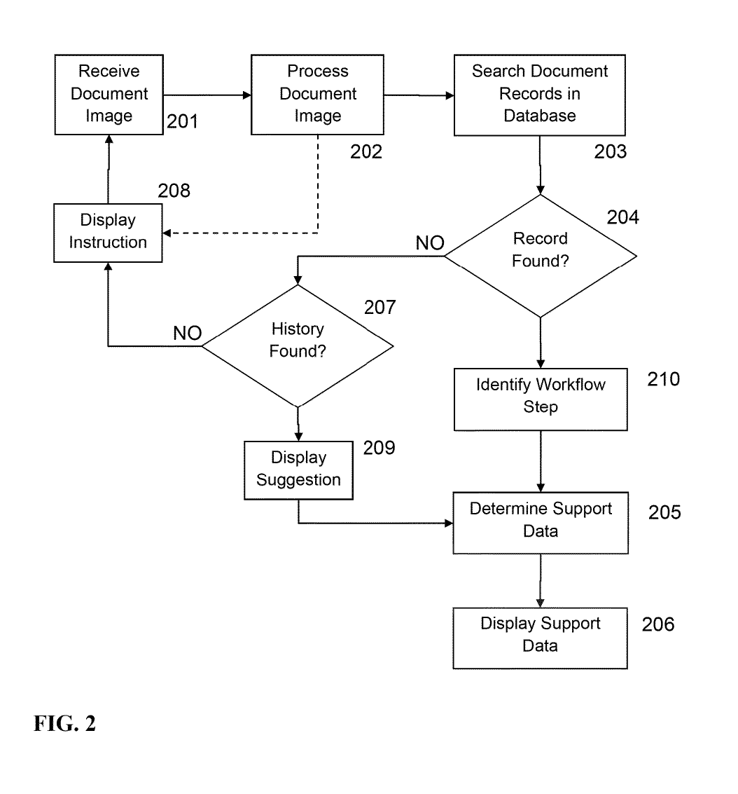

Reference is now made to FIG. 2, which is a flowchart of a method for providing document support data for presentation on an augmented reality display, according to some embodiments of the invention. The method receives automatically a document image 201 from the imaging sensor(s) 102 of an AR device 100, and processes automatically the document image to automatically compute the image content data 202. These method actions may be implemented on a processing unit 110 of the AR device 100, a processing unit 122 of a client terminal 120, a server 130, and the like. The document data records 141, as located on a database storage unit 140, are searched 203 automatically to locate the document record that contains the image content data until a match is found 204. Optionally, the user viewing the document is instructed to provide additional information to the method as at 208. For example, the user viewing the document is instructed to view the second page of the document, and further image content data is processed automatically from the second page document image. Optionally, the document type is identified automatically, and a history of user decisions for this document type is located 207, and a suggestion is displayed 209 on the display 103 based on the analysis of this history. When the document record 141 is found 204 in the database 140, the workflow step of the document is identified automatically by extracting the current document workflow step from the document record or comparing the image content data to the workflow fields of the document type record. Optionally, the current document workflow step is extracted from the document record and is compared to the image content data to confirm that the record workflow step of the document record is up to date and/or accurate. The document support data associated with this document record is selected and/or determined 205 automatically, by retrieving the next document workflow step, and extracting the relevant information from the document record and/or document type record needed by the user viewing the document to perform this step. The document support data is displayed 206 automatically on the display 103 of an AR device 100 so that the document support data is visible along with the document viewed by the user.

Following are several short examples to illustrate the method, which will be expended on in further detail later. For example, the face of a postal mail letter is imaged to produce a document image, the document image is identified as a priority mail, the addressee is identified, the user viewing the document is instructed to scan the back side of the envelope with the AR device, the sender is identified, the addressee is sent an electronic mail that the priority postal mail is received, and the user viewing the document places the postal mail in the addressee's mailbox. For example, invoices are imaged using an AR device when received in an accountant's office, the invoice data is automatically entered into a financial records database, and the user viewing the document is instructed with the AR device in which file to put the paper invoice. These examples illustrate the user decision as faster, easier, and less erroneous than a decision without the displayed support data, and further detailed examples will be elaborated herein.

For example, to support a user decision related to a specific document, the method captures this specific document image using an AR device 100. In this example, the user viewing the document brings the document into the frame of the imaging sensor(s) 102 and once the method captures a series of document images until the method identifies that the document image is suitable for image content data processing.

For example, the method identifies that all four corners are in view. For example, the method instructs the user viewing the document to align the document within a threshold tolerance to the raster lines of the imaging sensor(s) 102. When the image does not meet one or more of these conditions, the method may send an instruction to the user viewing the document using the AR device display 103 to perform the required corrective action, such as move the document and/or the imaging sensor(s) 102 to the left, right, tilt, hold still, and the like. For example, the method instructs the user viewing the document to hold the document being viewed motionless to prevent image blur. For example, the method instructs the imaging sensor to focus the lens of the imaging sensor(s) 102 on the document.

When a document image of sufficient quality is captured by the imaging sensor(s) 102 to identify the document content, the method proceeds to automatically process the document image to determine the image content data. For example, the captured image may be transmitted to a computerized client terminal 102 and/or server device 130 that may perform optical character recognition (OCR), document classification, recognition of numerical data fields in the document and their values, identification of a logo and/or photograph regions, and the like. The image content data may be used to match this specific document record and/or document type record from one or more databases on one or more data server devices.

Optionally, the image content data identified, such as data values, features, images and their location in the document image, are used for locating the document in the archive system, such as a database. For example, the text strings identified by the OCR process, and the location of each text strings in the document is used to locate the document record in the database. For example, the text strings identified by the OCR process are converted to numbers, and the value and location of the numbers in the document is used to locate the document record in the database, such as a document identification number. For example, distinguishing features such as lines, corners, boxes, graphical logos and like graphical elements are processed from the document image to produce vector data representation of the graphical elements along with the location of each graphical element in the document are used to locate the document record and/or the document type record in the database. For example, images such as raster logos, pictures, and like image elements of the document, and the location of each image element in the document, are used to locate the document record in the database by comparing known locations as recorded in the document records of the database. For example, the document type records contain field and values of graphical elements on a form, such as check boxes, and the graphical elements of the image content data are searched for in the database in these fields.

Optionally, any combination of text, numbers, graphics, and images of the image content data is used to locate the document record in the database by searching for this data in the values of fields of records of the database. Optionally, the user viewing the document is asked for additional input to uniquely identify the document record in the database. Optionally, the history of additional input from a user viewing a document is stored and used for suggestions of future identifications. For example, the image content data does not contain sufficiently unique data to identify a single document record in the database, and the user is asked to provide a second image content data be capturing an image of the second page of the document. Optionally, the image content data is used to find similar documents in the database, such as a document type, category, form, cluster, and the like. Optionally, the document record for this document is not found in the database, and a new record is created for this document based on one or more similar documents, such as a document, a document cluster, a document group, a document type, a form and the like.

Optionally, a set of rules are used to assign tags for fields of the document record and populate the field values of these tags. For example, the document type is identified as an unknown form, and the graphical elements of the form, such as boxes to fill in values are identified, the keywords for each box are identified, the data values written on the form are identified, and the new document type record is added to the document type database. In this example, a new document record is also added to the document database, assigned to this document type, and the fields for this document record are filled with the data values. Optionally, keyword rules, regular expression rules, image content position rules, matching database document record values, matching dictionary string values, and the like are used to assign values such as Document ID, page number, author, and the like.

Using multiple graphical and image content data elements make it possible to retrieve a document very rapidly without performing OCR, which is a costly process, thus saving time in identifying the document record in the database. Optionally, elements of image content data are processed one at a time from the document image, and after processing of each element, the database is searched for the document record, until a unique document record is identified.

The document record and/or the image content data may be used to determine the step of the document in the workflow process of this document. For example, the workflow for the document is identified as comprising steps 1 thru 5, and the image content data has values associated with steps 1, 2, and 3, the document is determined to be waiting for processing of step 4, and the document support data for step 4 is displayed to the user viewing the document. For example, the document is a bank loan form handed by a bank customer to a bank clerk, the internal use checkbox and name field on the form for showing that the form has been received are identified as being blank, and an instruction is sent to the display of the bank clerk to send the form to review by a loan officer for opening of a document record. For example, the document is a manuscript received by a secretary, and the editorial markup on the document indicates that an author of the document requires changes to the text of the manuscript, and an instruction is sent to the display to type in the changes to the document record.

Document support data may be determined from the workflow step, document record, and/or image content data.

Optionally, the document support data is displayed as a simple data display on the document view specifying the information. Optionally, the document support data is displayed using graphical indicators such as logos, large fonts, spaces between lines appropriate to the document position and transformation, and the like, augmenting the document with the document support data in the locations on the document best suited for viewing by the user. For example, the missing values of a form are displayed in the empty form boxes. For example, a blinking question mark is displayed next to a check box that needs to be checked. For example, document notes and/or comments are displayed in the margins of the paper document. For example, markup language is overlaid on the document text, such as strike-out of deleted text.

Optionally, when the image content data of the viewed document is not found explicitly in the database, the method determines that the image content data is associated with a cluster of documents in the database, such as a known type of document. The method may assign a classification of the viewed document to this document type, and determine information and/or instructions to the user viewing the document based on this document cluster and display these information and/or instructions to the user to support a decision regarding the actions for the viewed document. For example, when the document is a bank loan form not previously entered in the database and the bank account number field of the form is empty, the bank officer is instructed to ask the customer to fill out the account number. In this example, when the customer name is uniquely identified and associated with an account number the bank officer receives the customer's account number and fills out the missing information on the form. Further to this example, when the customer has several account numbers, the several account numbers and account information are displayed to the bank office on the document and the bank officer is instructed to choose one of the accounts.

Optionally, the image content data comprises one or more text strings and the like determined using optical character recognition applied to the document image.

Optionally, the text strings are located in by best match in an electronic dictionary, and corrected for spelling errors if needed. Optionally, the image content data comprises one or more numerical values and the like. Optionally, the image content data comprises one or more images and the like. Optionally, the image content data comprises one or more logos and the like.

Optionally, the document record comprises one or more field containing strings, values, images, and/or the like associated with the document. Optionally, the document record comprises one or more cross references to other documents, database records, and the like.

Optionally, the document workflow step is chosen from two or more workflow steps associated with the document type.

Optionally, the document workflow step is chosen from two or more workflow steps associated with the specific document.

Optionally, the document workflow step is undetermined and the user viewing the document is requested to supply a new workflow step specific to this document.

Optionally, and combination of the document image, content data, database record, type, group, cluster, current workflow step, other workflow steps, and/or the like are used to determine the document support data to display to the user viewing the document. For example, the next workflow step is displayed to the user viewing the document. For example, a value from the document record is displayed to the user viewing the document. For example, all modifications of the current image content compared to the document record are displayed to the user viewing the document, such as track changes. For example, multiple data and instructions are displayed to the user viewing the document. For example, data needed for blank fields of a form are displayed to the user viewing the document. For example, the document is a letter with an unknown recipient and the user viewing the letter face is shown in which physical mailbox to place the letter and automatically sends a notification to the addressee that mail is waiting in their mailbox.

Optionally, the document support data is displayed overlaid on the document image.

Optionally, the document support data is displayed overlaid on the printed document as viewed by the user.

Optionally, the document support data is displayed adjacent to the document as viewed by the user.

Optionally, the document support data is displayed in blank spaces on the document as viewed by the user.

Optionally, the document support data is formatted for font, color, lighting conditions and the like and displayed on the document as viewed by the user such that it appears as a part of said document.

Optionally, the document support data is formatted for pose, such as translation, rotation, skew and the like, and displayed on the document as viewed by the user such that it appears as a part of said document.

Optionally, the document is a paper document, a web document, an electronic document, and the like.

Optionally, the document physical medium is paper, a display terminal, an electronic book, a contract, an invoice, a form, an envelope, and the like.

Optionally, the augmented reality device comprises an imaging sensor(s) 102 for capturing a document image and a display to display the document support data. Optionally, the imaging sensor(s) 102 for capturing a document image and the display to display the document support data are separate computerized peripheral devices.

Optionally, the augmented reality device is a smartglasses. Optionally, the augmented reality device is a virtual reality device. Optionally, the augmented reality device is a head mounted display device.

Optionally, the computer processor instructions are executed on the AR device.

Optionally, the computer processor instructions are executed on one or more devices, distributed across a network.

Following is a detailed example of some embodiments of the method. According to this example, to capture an image of the document, a frame is selected from a video feed of an imaging sensor(s) 102 of the AR device 100. A grayscale filter is applied to the document image and a corner detection algorithm locates the image boundaries. The skew of document image is computed, and when the skew is greater than a threshold, such as a 7% skew, the next frame of the video feed is captured and an instruction to the user viewing the document to straighten the document is displayed on the AR device 102 using arrows. When the document image is suitable for further processing, the document image is cropped and de-skewed. When image blur is detected, the image may be discarded and the next image of the video feed automatically processed. The document image may be transformed to a black and white image to facilitate further processing. Once the image is suitable for further processing, the captured and pre-processed document image is transmitted to a client terminal 120 and/or image server 130.

On the client terminal 120 and/or image server 130, the document image is processed to determine the image document content. Optionally, this stage can be performed on a processing unit 110 of the AR device 100. Full page OCR processing is performed on the image to identify all textual data of the viewed document that can uniquely identify the document. For example, document unique identification content data is a document title, document name, document serial number, document form number, and the like. The image content data is used to match the document viewed by the user to pre-existing documents in the back enterprise server system 130, by searching a connected database 141 for fields matching the image content data of the document. If a unique document record is not found in the database, combinations of words from the document may be used for a full text search, until the document search results return only one document record. Optionally, a verification step is performed to compare text between the document record and image content data to verify that this is the right document within an acceptable probability.

When a match is determined, workflow step of the document is identified and the document support data for this document is determined. For example, authors, document status, current version number, significant changes since the document was printed, and the like. Region specific information on the document and the position of the information may also be determined from the workflow step, document record, image content, and/or document image. For example, a changed line or added sentence.

Document actions may also be determined from the workflow step and/or document record based on the document type, specific document status, document workflow, and the like. The document support data and/or other information are sent back to an AR device for presentation to the user together with the document being viewed.

The final stage of this example embodiment of the method is to present the document support data and/or other information on the AR device. A new frame from the video feed is selected as a new document image to format and display the document support data to. A grayscale filter is applied to the document image, and document boundaries are detected. The document support data, information to display, user instructions, and/or the like are formatted to the pose of the new document image, and set to the display device so that the user will view the information on or around the viewed document.

Benefits can be seen in two categories of use cases. The first category of use cases is when one person is facing another person, and there is a document which they are working on to filling in data or understand the document. By showing document filling instructions on the AR display devices, both participants can better understand how to complete the document. In this case, the proposed method will save time needed to stop the conversation, type information for which assistance is required on the computer, read the answers, and then revert back to the written document. Another advantage is when one of the participants wants to hide some of the information that this document implies from the other participant, such as a bank officer seeing internal credit information that the customer does not have access to. The bank officer having the AR display allows them to see the credit information once the customer is identified.

The second category of use cases is when a person is viewing a document and they need to make a decision based on the information written in that document. When not all of the information needed for the decision is located on the document itself, the device and method will automatically retrieve the extra information needed from one or more server systems, saving time and effort on the part of the decision maker.

Following are several use cases that exemplify some aspects of embodiments of the invention in each category. The first category shows use case examples of two or more people preparing a document.

For example, a life insurance agent is sitting in-front of an applicant for life or medical insurance. Together they are filling the forms needed for the application. As they are filling the forms, the information on the form is captured and processed automatically and the agent receives information about the applicant and the proposed policy while they are discussing the policy. Such information may include previous claims of the applicant, proposed coverage, estimated monthly fee, possible insurance plans for other family members, and the like.

For example, a bank customer sits in front of a bank officer to discuss a mortgage application. The customer presents to the banker their identification card and/or driver license, documents on the property they want to obtain a mortgage for, documents on the property he currently owns, and the like. The bank officer may immediately see details about the customer by looking at his ID card, such as credit history, current loans, other financial details, and the like and based on this information the bank officer may see displayed suggested interest rates. When going over the property documents the bank officer may see what the property worth is, whether there are any pending foreclosures on that property, and who the current owner is. This information may be displayed automatically without stopping the conversation with the customer, and without the officer needing to type the information on the computer.

The second use case category gives examples of a single person viewing a document.

For example, an accountant in a corporation receives an invoice, views the invoice with the AR device and the system automatically retrieves information on the invoice from the enterprise server. Information on who issued the purchase order (PO) for that invoice, name of person who approved the PO, the budget number associated with that invoice, was the invoice already paid, and the like are shown on the AR device display. The information may assist the accountant to process the invoice in less time than would be needed by looking up the information on a computer terminal. The information may also reduce the chance of human error by the accountant due to typographical errors when looking up the information or confusion between the multiple invoices.

For example, when a mail clerk working for a large enterprise sorts mail in a company mailroom. The mail clerk may receive a mail envelope addressed to a specific employee, such that the mail clerk does not know in which department and/or building the addressee works. In this example, the mail clerk receives precise information on how to forward the mail to the addressee just by looking at the envelope. The system will search the company directory for the addressee and display the department, the addressee's title and/or rank, and estimate the document's priority based on the mail sender information on the AR device. This information may allow the mail clerk to better decide how to forward the mail to the addressee without the mail clerk manually searching for the displayed information, saving the mail clerk's time and avoiding errors.

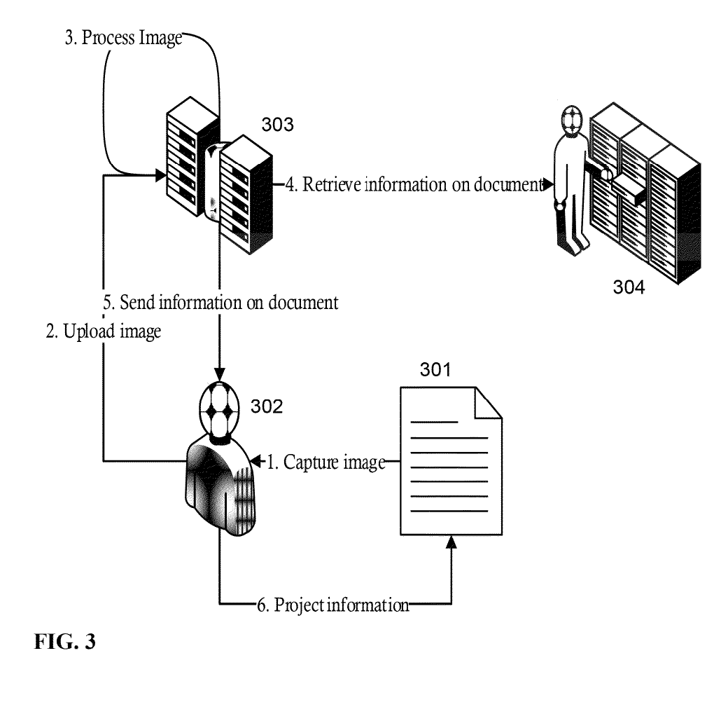

Reference is now made to FIG. 3, which is an illustrative schematic drawing of a system and method for providing document support data for presentation on an augmented reality display, according to some embodiments of the invention. In the example workflow, a document 301 is viewed by a user 302, and an imaging sensor(s) captures an image of the document. The document image is sent to a client terminal and/or server 303 where the document image is processed to compute the content data of the document. The image content data is optionally sent to a database server 304 to retrieve the document record, instructions, and/or document type record from a database. The retrieved information is returned to the client terminal and/or server 303, and sent to the AR device to be viewed by the user 302 together with the document 301 to support a decision by the user 302 of the next actions for that document 301.

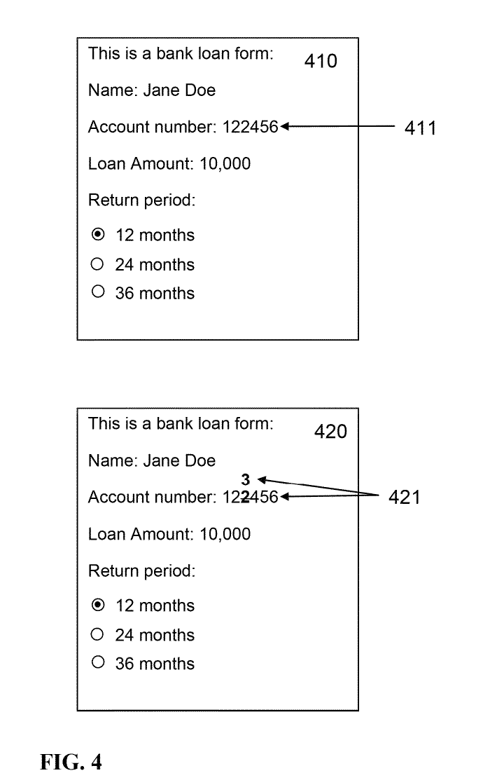

Reference is now made to FIG. 4, which is illustrative schematic drawing of user view of a document and document support information for presentation on an augmented reality display, according to some embodiments of the invention. The loan document being viewed by a user 410 shows fields and values of each field 411. After retrieving the document record and/or account information from the database, the view of the document as seen by the user is update 420 to show that an error has been detected in the field for the account number, and the error is highlighted and a suggested correction is shown 421 as an overlay of the document.

The flowchart and block diagrams in the Figures illustrate the architecture, functionality, and operation of possible implementations of systems, methods and computer program products according to various embodiments of the present invention.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant databases will be developed and the scope of the term database is intended to include all such new technologies a priori.

It is expected that during the life of a patent maturing from this application many relevant augmented reality devices will be developed and the scope of the term augmented reality device is intended to include all such new technologies a priori.

It is expected that during the life of a patent maturing from this application many relevant document types will be developed and the scope of the document type is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method to generate an augmented document display, comprising:
receiving a document image from an augmented reality device, wherein said document image images a document currently viewed by a user;
processing said document image to identify an image content data of said document;
selecting one of a plurality of document records based on said image content data;
identifying a current workflow step of said document from a plurality of document workflow steps, using said selected document record;
determining at least one document support data based on said current workflow step; and
instructing said augmented reality device to display said at least one document support data when said document is viewed by said user.

2. The computerized method of claim 1, wherein said current workflow step is identified using said image content data in addition to said selected document record.

3. The computerized method of claim 1, wherein said at least one document support data is determining based on any from said plurality of workflow steps, said selected document record, and said image content data in addition to said current workflow step.

4. The computerized method of claim 1, wherein said image content data is any form a list of text data, numeric data, graphical data and image data.

5. The computerized method of claim 4, wherein each element of said image content data further comprises a location in said document image of each element of said image content data.

6. The computerized method of claim 1, wherein said at least one document support data is any from a list of a document support action, a document support instruction, a document support suggestion, a value of said selected document record, one of said plurality of workflow steps, and a value of one of said plurality of document records.

7. The computerized method of claim 1, wherein said at least one document support data is at least one document modification data computed from a comparison of said selected document record and said image content data.

8. The method of claim 1, wherein said at least one document support data is determined from at least one field value of said selected document record.

9. The method of claim 1, wherein said at least one document support data comprises an instruction associated with said document image.

10. The method of claim 1, wherein said image content data comprises a plurality of values, a type of each value being any from a list of characters, numbers, pictures, images, and logos.

11. The method of claim 7, wherein said image content data comprises a plurality of characters, and said plurality of characters are identified using optical character recognition.

12. The method of claim 1, wherein said one of a plurality of document records is selected by a best matching of said image content data to at least one value from said selected document record.

13. The method of claim 1, wherein said image content data matches a plurality of matching document records, and one of said plurality of matching document records is selected by receiving a user selection decision.

14. The method of claim 1, wherein said image content data matches a plurality of document records, and said selected document record is selected by comparing a plurality of previous user selection decisions associated with said plurality of document records.

15. The method of claim 1, wherein said plurality of document records are stored in any from a list of a table, a database, a server, and a database server.

16. The method of claim 1, wherein said plurality of document records are a plurality of document clusters, said selected document record is a selected document cluster based on said image content data being related to said selected document cluster.

17. The method of claim 1, wherein said instructing of said augmented reality device to display said document support data comprises modifying a formatting of said document support data so that when viewed by said user said document support data appears as part of said document.

18. The method of claim 1, wherein said instructing of said augmented reality device to display said document support data further comprises instructing to display said document image in addition to said document support data.

19. The method of claim 1, wherein said selecting one of a plurality of document records is performed on secondary server device dedicated to storing of said plurality of document records.

20. The method of claim 1, wherein said determining document support data from said selected document record is performed on secondary server device dedicated to storing of said plurality of document records.

21. A computer readable medium comprising computer executable instructions adapted to perform the method of claim 1.

22. A computerized device for generating an augmented document display, comprising:
at least one computerized processing unit for executing processor instructions;
an identification module which is configured to receive a document image from an augmented reality device, and identify an image content data of said document image;
a selection module which is configured to receive said image content data, select one of a plurality of document records, identify a document workflow step from a plurality of workflow steps using said selected document record, and determine at least one document support data based on said current workflow step; and
a display module which receives said document support data, modifies a format of said document support data to correspond to said document image, and instructs said augmented reality device to display said document support data.

23. A computer program product for generating an augmented document display, said computer program product comprising:
a computer readable storage medium having stored thereon:
first program instructions executable by a computerized device to cause a device to capture a document image from an imaging sensor, wherein said document image images a document currently viewed by a user;
second program instructions executable by said computerized device to cause said device to process said document image to identify an image content data of said document;
third program instructions executable by said computerized device to cause said device to select one of a plurality of document records based on said image content data;
fourth program instructions executable by said computerized device to cause said device to identify a current workflow step of said document from a plurality of workflow steps, using said selected document record;
fifth program instructions executable by said computerized device to cause said device to determine at least one document support data based on said current workflow step; and
sixth program instructions executable by said computerized device to cause said device to instruct said augmented reality device to display said at least one document support data when said document is viewed by said user.
